(19) United States
(12) Patent Application Publication
(10) Pub. No.: US 2008/0043272 A1
(43) Pub. Date: Feb. 21, 2008

(54) Method, system and article for exposing printer functionality via a logical file system

(75) Inventor: Lars-Ake Berg, Kungsbacka (SE)

Correspondence Address: SEED INTELLECTUAL PROPERTY LAW GROUP PLLC, 701 FIFTH AVENUE, SUITE 5400, SEATTLE, WA, 98104-7092, US

(73) Assignee: Intermec IP Corp., Woodland Hills, CA (US)

(21) Appl. No.: 11/506,647

(22) Filed: Aug. 18, 2006

(51) Int. Cl. G06F 3/12

(52) U.S. Cl. 358/1.13

(57) ABSTRACT

A method, system, and article facilitate the configuration, supervision, and interaction with a non-storage special-purpose device, such as a barcode printer, using standard file operations on a logical file system. Once the logical file system has been created, logical files and logical directories can be manipulated using standard file manipulation techniques with corresponding functionality, such as updating firmware or installing fonts, carried out on or by the special-purpose device. Any errors that occur when trying to perform the associated functionality result in standard operating system error messages. In addition, in one embodiment, a remote computer may access the logical file system to perform remote configuration and supervision.

### BACKGROUND OF THE INVENTION

1. Field of the Invention

This disclosure generally relates to exposing non-storage, special-purpose device functionality via a logical file system, such as to allow configuration, supervision and/or interaction with a special-purpose printer using standard file operations.

2. Description of the Related Art

Although many operating systems support the use of drivers to maintain a standard way to interact with devices, the generalized driver interface for various types of devices often do not provide access to all functionality available on a particular device, especially on special-purpose devices. For example, while the operating system may support printer drivers for standard interaction with all types of printers, the general printer driver interface may not support updating firmware for the printer, installing fonts on the printer, tracking the amount of toner/ink left, or tracking the amount of printing media left. The problem is compounded further when a special-purpose printer is involved. A barcode printer, for instance, may need to compute/generate checksums for one or more barcodes it is printing or keep track of unique identifiers, such as serial numbers, that need to be printed on the barcode label. An identification card printer may similarly need to keep track of various card layouts or authenticate the user printing the identification card.

As a result, non-standard software must be installed to provide access to the additional functionality. The non-standard software makes the process of using the additional functionality complex for end-users and requires additional training for usage. In addition, for the device manufacturer, significant effort must be expended creating both a driver and the non-standard software for each supported operating system.

At the same time, there is a standard way of manipulating files and directories in the file system. Programs can easily be written that are able to read, write, create, and delete files and browse directories. Well-defined error messages occur when file input/output is not possible. Most operating systems also have tools to format a disk, viewers and/or editors for a particular type of file and a file browser that shows directories and files. Users are also proficient at manipulating files and need little or no training to manipulate directories and/or files. In addition, there are various standard manners, such as FTP, SMB/CIFS, or NFS, in which a remote file system may be accessed by a remote computer including a remote computer running a different operating system.

### BRIEF SUMMARY

A method, system, and article facilitate the configuration, supervision, and interaction with a non-storage, special-purpose device, such as a barcode printer, using standard file operations on a logical file system. Once the logical file system has been created, logical files and logical directories can be manipulated using standard file manipulation techniques with corresponding functionality, such as updating firmware, carried out on or by the special-purpose device. Any errors that occur when trying to perform the associated functionality result in standard operating system error messages. In addition, in one embodiment a remote computer may access the logical file system to perform remote configuration and supervision.

In one aspect, a computer-implemented method for exposing printing device functionality via a logical file system, comprises: creating a logical file system, by creating one or more predefined logical directories, and creating one or more logical files in the created directories, at least some of the logical files associated with at least one functionality of a printing device; mounting the logical file system; and in response to programs manipulating one or more logical files using a standard file operation, interacting with the printing device to perform the associated functionality, wherein the standard file operations include create, write, read, and delete.

In another aspect, a computer readable medium causes a mobile computing system to expose printing device functionality via a logical file system by creating a logical file system, by creating one or more predefined logical directories; and creating one or more logical files in at least some of the created directories, at least some virtual files associated with at least one printing device functionality, the virtual files including at least one status file and at least one configuration file; mounting the logical file system; in response to a program manipulating one or more virtual files using at least one standard file operation, interacting with the printer to perform the functionality associated with the one or more files, wherein the standard file operations include create, write, read, and delete; and automatically updating the at least one status file.

In another aspect, a computing device for exposing printing device functionality via a logical file system comprises: a memory; a logical file system, the logical file system having one or more logical directories, the logical directories having logical files, at least some of the logical files associated with at least one functionality of a printing device; and a first module that in response to a program manipulating one or more logical files using at least one standard file operation, performing the functionality associated with the one or more files on the printing device, wherein the standard file operations include create, write, read, and delete.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of an environment to use a logical file system to manipulate a special-purpose device according to one illustrated embodiment.

FIG. 2A is a front view of a logical file system according to one embodiment as displayed in a standard graphical file browser.

FIG. 2B is a front view of a logical file system according to one embodiment as displayed in a text-based file browser.

FIG. 3 is a block diagram illustrating an embodiment of a computing system suitable for hosting the logical file system and a special-purpose device on which the logical file system acts.

FIG. 4 is a tree diagram of an example logical file system for a barcode printer according to one embodiment.

FIG. 5 is a flow diagram of an example computer-implemented method for exposing printing device functionality via a logical file system according to one embodiment.

FIG. 6 is a flow diagram of an example method of creating a logical file system according to one embodiment.

FIG. 7 is a flow diagram of an example file/directory manipulation routine according to one embodiment.

FIG. 8 is a flow diagram of an example routine for carrying out the logical file's functionality according to one embodiment.

### DETAILED DESCRIPTION OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with printers, networks, and computing systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment”, “some embodiments” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Non-storage, special-purpose devices may include, but are not limited to, barcode or other machine readable symbol printers, RFID encoders, ID card printers, check printers, magnetic card encoders, CD/DVD disc printers, ticket printers, date printers (such as printers that print expiration dates), lot number printers, plotters, rubber stamp makers, programmable keyboards, programmable foot pedals and LED message boards.

For ease of understanding, a barcode printer will be used as an illustrative special-purpose device but such should not be considered limiting.

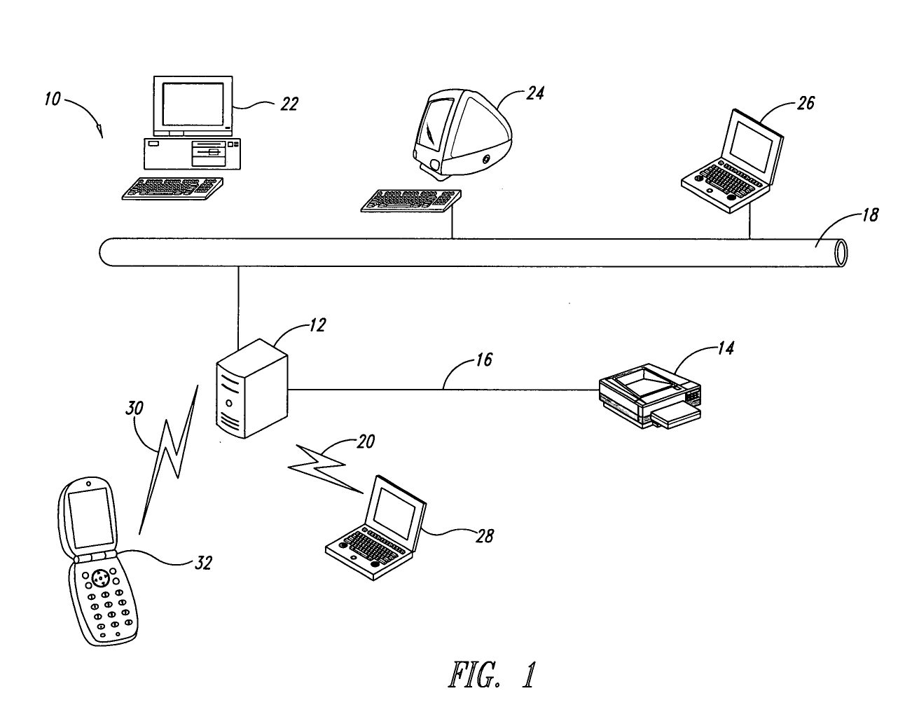

FIG. 1 shows an environment 10 in which a logical file system is used to manipulate a special-purpose device 14 according to one illustrated embodiment. In one embodiment, the host computer 12 hosts the logical file system although in other embodiments the logical file system may reside on the special-purpose device itself and be exported, such as exporting the logical file system as USB mass storage. The host computer 12 may be attached to multiple networks including a wired-based network 18, a local area wireless network 20 (e.g., 802.11x or Bluetooth) or a wide-area wireless network 30. The wired network 18 may, for example, be an Ethernet-based local area network or may be a connection to wide-area networks such as the Internet. Various client computers, such as a desktop 22, an Apple Macintosh® computer 24, a laptop 26 may access the logical file system on the host computer over the wired network. Other computers, such as the laptop 28, may access the logical file system via the local area wireless network 20 to access the logical file system on host computer 12. In some embodiments, the logical file system may be accessed from a mobile device 32 over a wide-area wireless network 30 such as a cellular-based network. In some embodiments, at least some of the logical files are advantageously text-based so as to facilitate remote configuration and management using the mobile device 32. Various file client programs may facilitate remote file system access, whether built into the operating system or separately acquired. For the sake of clarity only a single device is illustrated, however multiple clients of the same type may actually have access to the logical file system. For example, multiple desktop computers 22 may have access to the host computer 12. Furthermore, a single host computer 12 may have multiple logical file systems for facilitating configuration and management of multiple special-purpose devices.

The host computer 12 is connected to the special-purpose device 14 by cable 16 however in other embodiments the host computer 12 may be connected to the special-purpose device 14 in other manners such as over one or more of the illustrated networks.

The host computer may be running any operating system, for example, Windows®, MacOS®, UNIX, or Linux. The host computer may have software that allows remote access to its file system via a file server such as an FTP server or a SMB/CIFS server. In some embodiments, the file server may be a standard feature of the operating system distribution although in other embodiments third-party software may be used for remote file access.

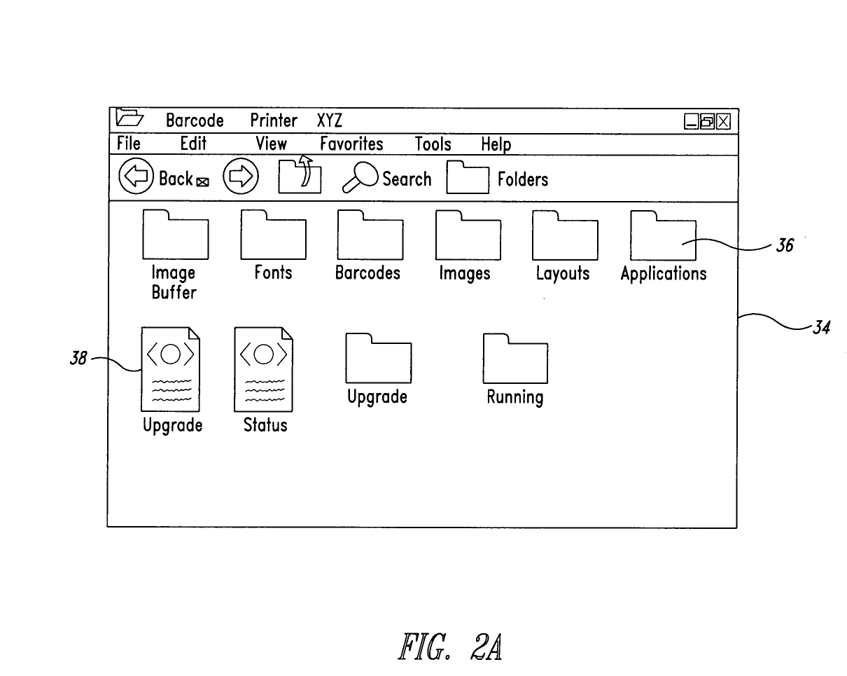

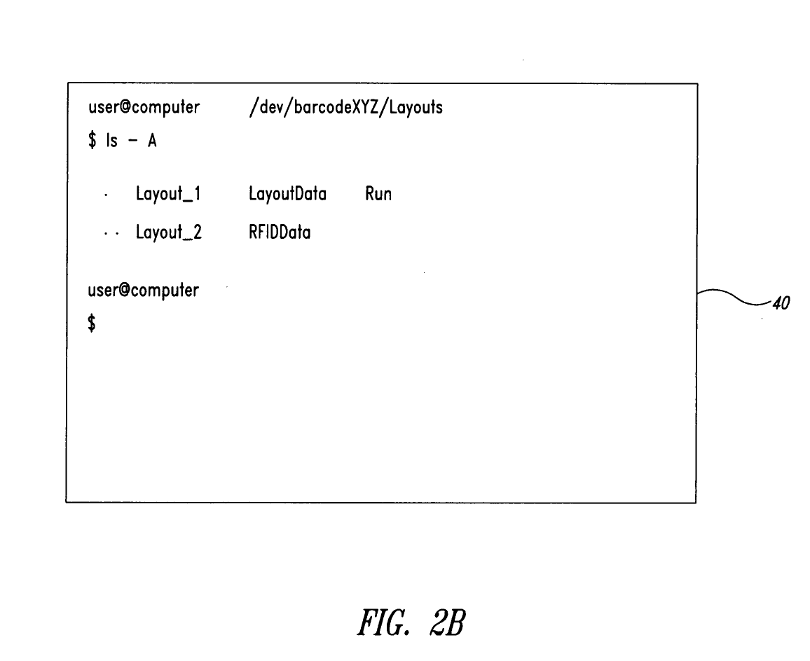

FIGS. 2A-2B are examples of the logical file system as shown in the operating system's file browser. FIG. 2A is a front view of a logical file system according to one embodiment as displayed in a standard graphical file browser 34, such as the file browser on Microsoft Windows®. The graphical file browser displays various directories 36 and files 38. In one embodiment, one or more of the directories (e.g., the Upgrade directory, which allows firmware to be updated) may be hidden and not displayed by default. Although the directories are illustrated in icon view, the logical file system may be displayed in other views such as list, details, or tiles.

FIG. 2B is a front view of a subset of the logical file system as displayed on a command-line file browser 40, such as on UNIX and UNIX-like systems.

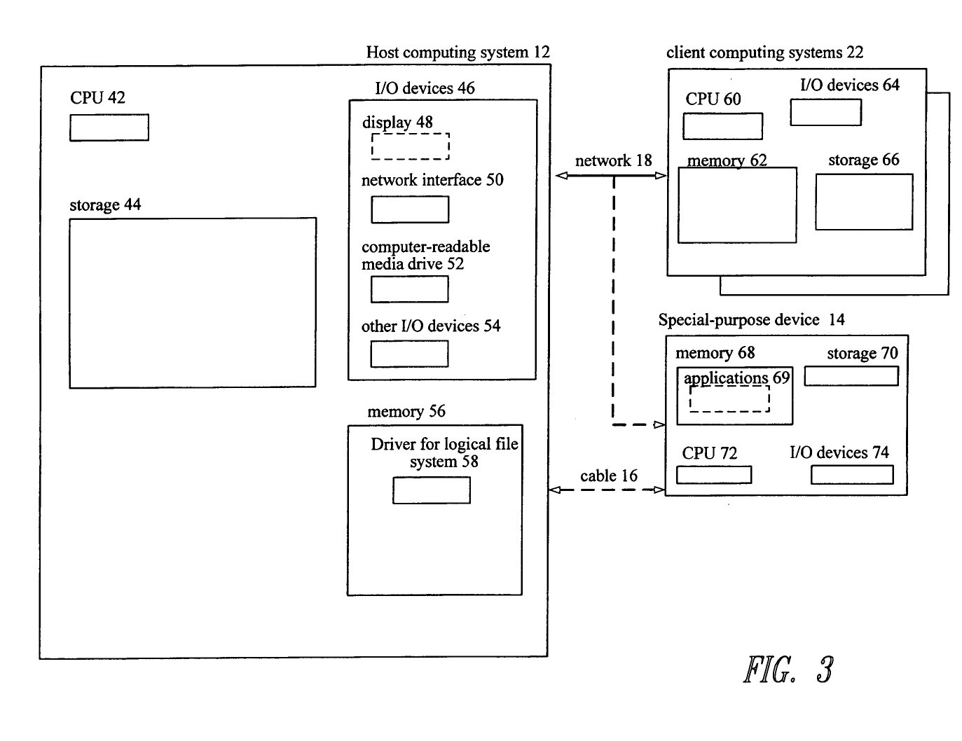

FIG. 3 is a block diagram illustrating an embodiment of a computing system suitable for hosting the logical file system and a special-purpose device on which the logical file system acts. The host computer 12 includes a CPU 42, various I/O components 46, storage 44, and memory 56. The I/O components may include a display 48, a network interface 50, a computer-readable media drive 52, and other I/O devices 54. The illustrated embodiment contains a driver 58 for the logical file system in memory 56. The driver creates the logical file system and in response to file and/or directory manipulation, performs the associated operation on or regarding the special-purpose device 14.

The client computing systems 22 includes a CPU 60, I/O devices 64, memory 62, and storage 66. The client computing system may remotely access the logical file system on the host computer system 12. The special purpose device 14 may include a CPU 72, I/O devices 74, storage 70, and memory 68. In the memory 68 may be a number of applications 69 executing on the special-purpose device if the special-purpose device supports locally running applications.

It will be appreciated that the illustrated computing systems are merely illustrative and are not intended to limit the scope of the present invention. The host computing system 12 may be connected to other devices that are not illustrated, including through one or more networks for example the Internet or the Web. More generally, the various computing systems may each comprise any combination of hardware and software that can interact in the manners described, including computers, network devices, internet appliances, PDAs (“Personal Digital Assistants”), wireless phones, pagers, electronic organizers, television-based systems and other various consumer products that include inter-communication capabilities. In addition, the functionality provided by driver illustrated in FIG. 3 may in some embodiments be distributed in additional components.

Alternatively, in other embodiments some or all of the software components may execute in memory on another device and communicate with an illustrated computing system or device via inter-computer communication. Some or all of the components or data structures may also be stored (e.g., as instructions or structured data) on a computer-readable medium, such as a hard disk, a memory, a network, or a portable article to be read by an appropriate drive. The components and data structures can also be transmitted as generated data signals (e.g., as part of a carrier wave) on a variety of computer-readable transmission mediums, including wireless-based and wired/cable-based mediums. Accordingly, the various embodiments may be practiced with other computer system configurations.

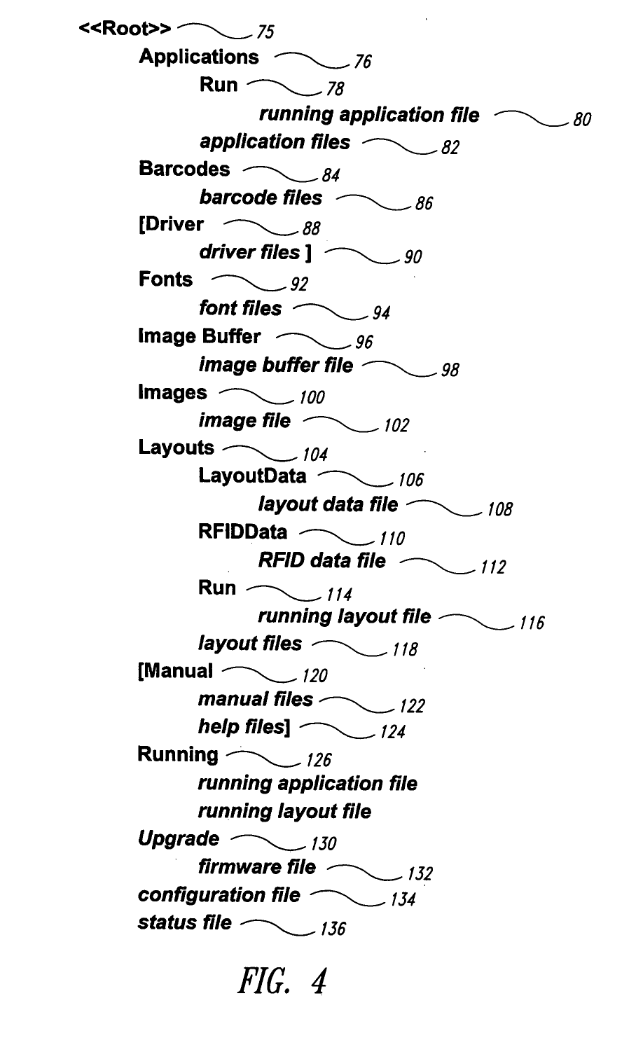

FIG. 4 is a tree structure of the logical file system according to one embodiment for a barcode printer. The root directory 75 displays a list of folders and files when browsed. If the root directory is formatted, factory defaults may be restored. The root directory also has a configuration file 134 and a status file 136. In some embodiments, there may be multiple configuration files and/or multiple status files. The status file 136 and the configuration file 134 are preferably text-based such as XML, text, or comma-separate values. The status file 136 may launch the appropriate viewer and/or editor. In some embodiments, there may be one or more XSL, XSLT or CSS files so that an XML-based status file may be displayed graphically in the default web browser.

Generally, there are a number of default actions that may occur on the logical files and directories. For example, logical directories may not be created or deleted and if a program (other than the driver) tries to create or delete a logical directory, an error message be generated. As a second example, when directories are browsed, the driver may update the logical files in the directory based on the current state of the barcode printer. For example, when the Running directory is selected, the driver may determine what is currently running and automatically generate the corresponding logical files. In addition, when directories are formatted, generally the factory defaults are restored. By default, when using the operating system's file browser, the read operation on a logical file opens the logical file in the program associated with the file type of the logical file; user programs may also read the logical files as well in order to process the logical files.

If the barcode printer is capable of running one or more applications, the logical file system may have an applications directory. The Applications directory 76 contains one or more application files 82 capable of being run on the barcode printer and a Run subdirectory 78 containing the currently running application 80 or applications. Applications may, for example, compute/generate checksums or keep track of unique identifiers, such as serial numbers or lot numbers, that need to be printed. If the applications directory is formatted, the default applications are restored. On an attempted create or delete operation by the user for the Applications directory 76 or the Run subdirectory 78, a standard directory error is generated. If an application file is created or written in the applications directory, after checking the file format, the application is installed on the special-purpose device. If an application file is deleted from the logical file system, the application is deleted from the special-purpose device. A format operation on the Run sub-folder stops the currently executing applications. When an application file is placed into the Run subfolder 78, the application is executed on the special-purpose device and when the application file is deleted from the Run subdirectory 78, the application stops executing. In some embodiments, an application must be installed on the special-purpose device by placing the application file in the Applications directory 76 before the application may be run by placing the application file in the Run subdirectory.

The Barcode directory 84 contains all installed bar code symbologies and allows additional barcode symbologies to be installed. As barcode files 86 are added to the directory, each file is checked to make sure the file is of a legal file format and if so, the barcode is installed on the printer. If the barcode file is not of a legal format or the printer's memory is full, an error message is generated. If a barcode file 86 is deleted from the barcode directory 84, then the barcode symbology is removed from the printer.

The Fonts directory 92 contains font files 94 representing the fonts installed on the barcode printer and allows fonts to be installed or deleted on the barcode printer. As with the barcode directory, any files added to the directory are checked to make sure that they are of the right format before installing. Additionally, if the memory on the barcode printer is full, a standard error message will be generated.

The Image Buffer directory 96 may contain an image buffer file 98. When the directory is formatted, the image buffer file is removed. The one or more image buffer files 98 may be bitmap images of the currently printing or previously printed layout, or portions thereof. In one embodiment, the image buffer files are in the operating system's standard image format such as Windows Bitmap (i.e. *.bmp). Advantageously, since the file is in the standard image format for an operating system, the appropriate viewer or editor may be launched when the file in opened in the file browser. If a file is written to the image buffer and the image is of a known format, then the image is printed and the old image buffer file is replaced. In some embodiments, the image file may need to be written to the Images directory before being placed into the Image Buffer directory and printed.

The Images directory 100 contains images used in layouts. When an image file 102 is read, the file may be opened in the appropriate image viewer and/or editor on the host computer. When an image file is written to the Images directory 100, the image is installed on the printer. A delete operation removes the image from the printer. The images files may preferably be bitmap images.

The Layouts directory 104 contains all layouts. The Layout directory may contain a LayoutData 106, RFIDData 110 and Run 114 subdirectories and one or more layout files 118. A layout may be added by writing a layout file to the Layouts directory and may be removed by deleting the logical layout file. The Run subdirectory 114 contains the running layout file 116, if any. If the Run subdirectory 114 is formatted, the printer stops executing the current layout. In one embodiment, a new layout may be used if one of the layout files is copied to the running subdirectory 114 although in other embodiments the layout file may be written to the Run subdirectory without first being installed on the printer. By deleting the running layout file, current execution of the layout is stopped.

The LayoutData subdirectory 106 contains one or more data files used when printing a layout if required. The data files 108 may be written to the directory to supply information such as the serial number when the serial number is supplied by an application running on the host computer or a remote computer. If a necessary data file is removed, execution of the layout is stopped.

If the barcode printer can encode RFID data, an RFIDData subdirectory 110 may exist containing RFIDData files 112. The RFIDData subdirectory 110 contains data necessary or desirable for the currently running Layout. If the RFIDData subdirectory 110 is formatted and some RFID data is required by the layout, execution of the layout is stopped. Similarly, if RFID data is needed when a layout is printed on the barcode printer, then the execution of the layout is also stopped when the RFIDData file is removed. RFIDData files may supply data from an application running on the host computer or a remote computer.

The Running directory 126 contains the logical files that are currently running on the barcode printer. The logical files include the running layout file in the Run subdirectory 114 of the Layouts 104 directory and the one or more running application files in the Run subdirectory 78 of the Applications directory 76. The logical files may be copies of the running files or the logical files may be hard or soft links to the logical files in the Run subdirectories. In one embodiment, if a file is placed in the Running directory by a program, the logical file is copied to the corresponding Run subdirectory with the appropriate functionality carried out. If the directory is formatted, current execution of the one or more applications and the current layout is stopped. In one embodiment, the Running directory may also include the image buffer file 98 in the Image Buffer 96 directory.

The Upgrade directory 130 allows upgrades to the barcode printer's firmware once the firmware's legitimacy has been established. After a firmware file 132 is written to the upgrade directory, the legitimacy of the firmware file 132 may be determined by verifying a checksum or digital signature attached to the firmware file. In one embodiment, the upgrade directory 130 is hidden so that casual users cannot update the firmware. However, advantageously, a single IT administrator can deploy firmware updates organization-wide by mounting the logical file system associated with all the barcode printers in the organization.

It will be appreciated that the illustrated logical file system is merely exemplary and the logical file system may be structured in various manners in various embodiments. For example, the names of the individual directories or subdirectories may be different in other embodiments. In addition, the logical file system may be structured differently for different types of special-purpose devices.

In addition, in some embodiments, one or more of the logical directories may be password-protected or otherwise have access restricted via an access control list. Similarly, in some embodiments, file locking may be utilized to prevent multiple computers from interfering with each other. For instance, one computer may be prevented from adding something to the Run subdirectory that would interfere with another computer's print job. In addition, there may be one or more fonts or barcode symbologies that cannot be removed from the barcode printer.

The illustrated embodiment also illustrates optional directories and files such as directories containing native printer drivers, printer manuals and other documentation, which may not be available in other embodiments. The Driver directory 88 contains one or more driver files 90. The drivers may include traditional printer drivers or drivers for the logical file system for other operating systems. The Manual directory 120 has both manual files 122 and help files 124. The manual files may, for example, be PDFs (“Portable Document File”) and the help files may be the default help files for the operating system such as man pages for UNIX or CHM (“Compiled HTML Help”) files for Microsoft Windows®.

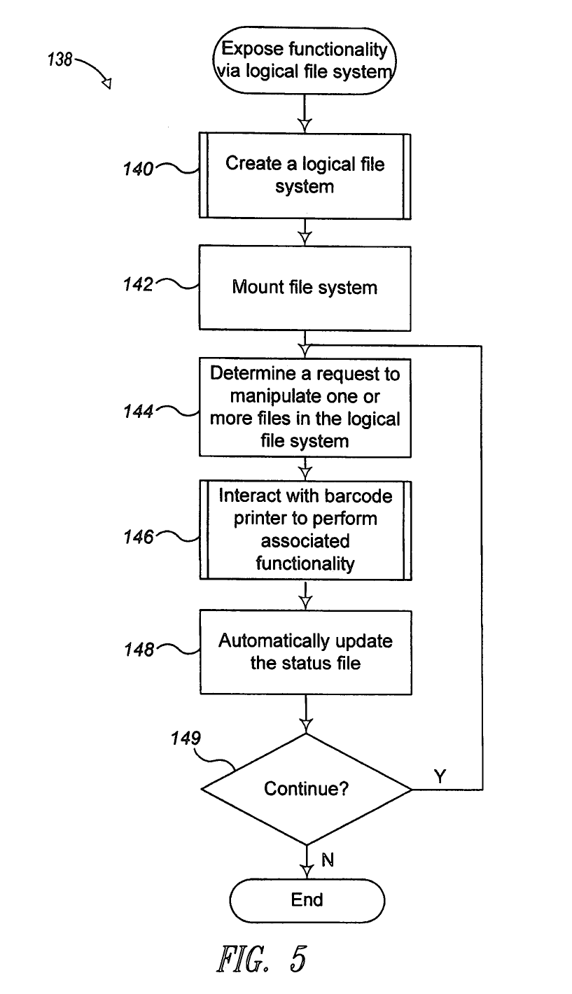

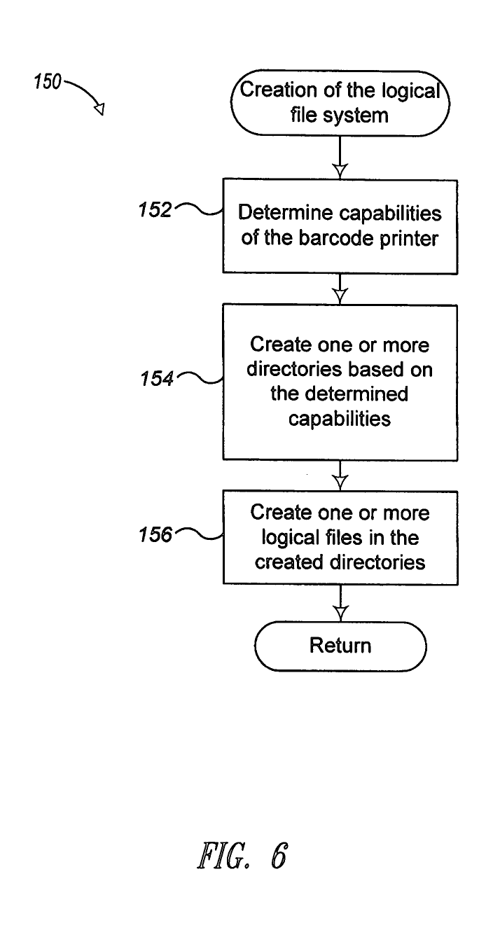

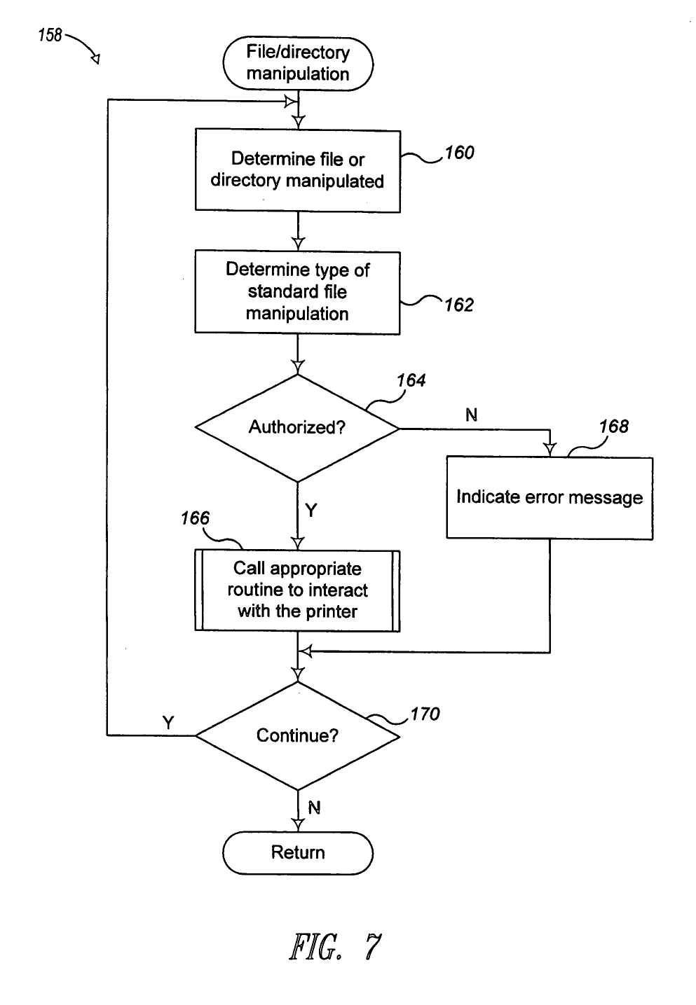

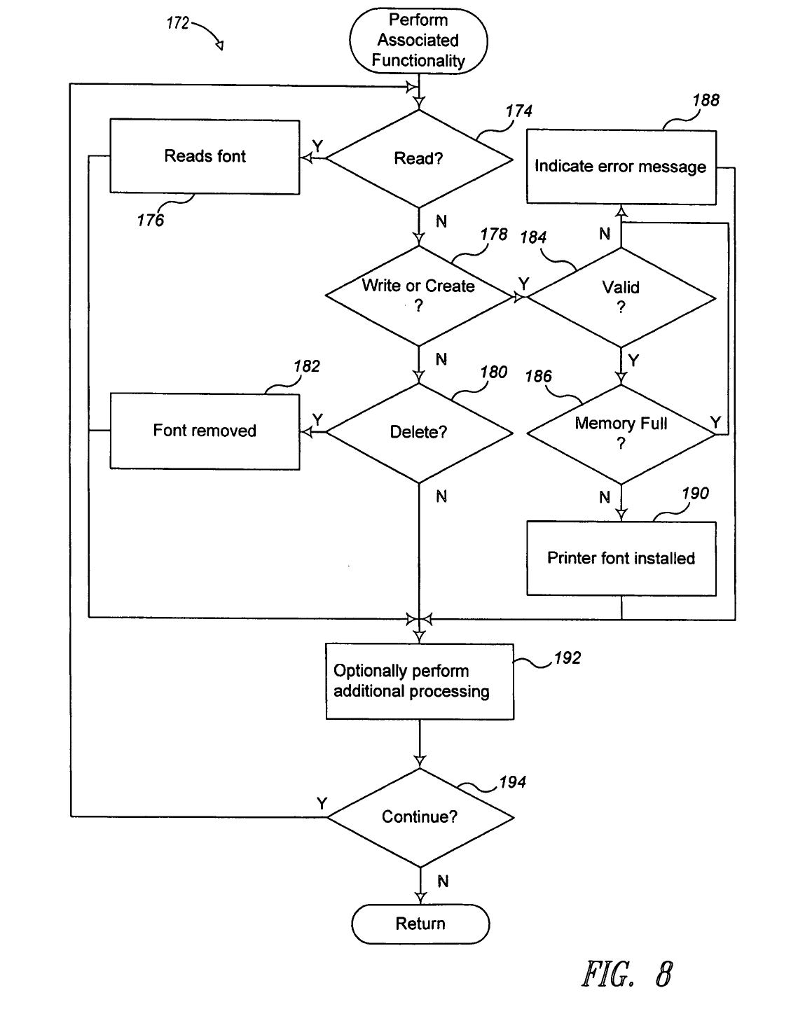

FIG. 5 is a flow diagram of an example computer-implemented method 138 for exposing printing device functionality via a logical file system according to one embodiment. The method begins at 140, where a logical file system is created. The logical file system may be created by the example routine illustrated in FIG. 6. From 140, the method continues to 142, where the logical file system is mounted. The logical file system may be mounted as its own logical drive in some embodiments although in other embodiments the logical file system may be mounted as a directory of the host computer's file system. After mounting the file system, the method continues to 144, where a request to manipulate a file or directory is determined. An operating system file browser or a third-party program may, for instance, generate the request. After the request is determined, the method continues to 146, where the barcode printer is interacted with to perform the associated functionality. In some embodiments, interactions with the barcode printer occur in one or more routines called to perform the interactions such as the routines in FIGS. 7 and 8. From 146, the method continues to 148, where the status file is automatically updated. The file may be updated to reflect the new amount of memory left on the special-purpose device or the amount of a consumable supply left. After the status file is updated, the routine determines whether to continue at 149. If so, the routine proceeds to 144 and if not ends.

FIG. 6 is a flow diagram of an example routine 150 of creating a logical file system according to one embodiment. The routine may be invoked at 140 of FIG. 5. The routine begins at 152, where the capabilities of the barcode printer are determined. The determination may include, for example, determining which fonts and barcodes are installed on the barcode printer. The determination may also be based on the barcode printer's capabilities to encode RFID data or run applications. Advantageously, the determination of the capabilities of the barcode printer may allow the same driver to be used for the same family of barcode printers. After determining the capabilities of the barcode printer, the routine continues to 154, where one or more logical directories are created based on the determined capabilities. After creating the logical directories, the method continues to 156, where one or more logical files are created in the logical directories. The logical files may be based on the determined capabilities of the barcode printer such as creating a font file for each font currently installed on the barcode printer or a creating a barcode file for each font currently installed on the barcode printer.

FIG. 7 is a flow diagram of an example file/directory manipulation routine 158 according to one embodiment. The routine may be invoked at 146 of FIG. 5. The routine begins at 160, where the routine determines which file or directory is manipulated. After determining the file or directory manipulated, the method continues to 162, where the routine determines the type of file or directory manipulation File manipulation includes read, write, delete, and create; directory manipulation includes browse, create, delete, and format. From 162, the routine continues to 164, where it determines if the file or directory operation is authorized. The determination of whether the file or directory manipulation is authorized may include determining whether access control to the file or directory is satisfied, whether the file is locked or whether the file operation is legal. If the operation is authorized, the routine proceeds to 166 by calling the appropriate directory or file manipulation routine to manipulate the bar code printer. The appropriate routine is determined at least in part on the file or directory being manipulated. In one embodiment, the appropriate routine may also be determined at least in part on the type of file or directory manipulation. FIG. 8 illustrates an example routine that may be called; however, in other embodiments, the functionality of the called routines may be combined into the file/directory manipulation routine. If the operation is not authorized, then an error message is indicated in 168. After indicating the error or calling the appropriate routine to interact with the printer, the routine determines whether to continue at 170. If so, the routine proceeds to 160 and if not returns.

FIG. 8 is a flow diagram of an example routine 172 for carrying out functionality on the special-purpose device according to one embodiment. In particular, the illustrated routine corresponds with the manipulations of font files 94 in the Fonts directory 92. The routine may be invoked at 166 of FIG. 7 and beings at 174, where the routine determines if the standard file operation is a read operation and if so, proceeds to 176, where the font is read and if not proceeds to 178. During 178, the routine determines if the file operation is a create or write operation and if so proceeds to 184 and if not proceeds to 180. In 184, the routine determines if the font file is valid. The file is valid if the file is of the right format, such as a TrueType font or Postscript Type 1 fonts. If the font is not valid, an error is indicated in 188 and the routine continues to 192. Otherwise, the routine proceeds to 186 to determine if the memory of the special-purpose device is full. If so, an error is indicated in 188 and the routine continues to 192. If the memory is not full, the routine continues to 190, where the font is installed on the printer.

If the file operation was determined not to be a write or create operation at 178, then the routine continues to 180, where the routine determines if the file operation is delete. If the file operation is delete, then the routine removes the font at 182. After removing the font or if the file operation is not delete, the routine continues to 192, where the routine optionally performs additional processing. The additional processing may include logging the file access, perform file locking management, indicating a successful result and/or processing other file operations such as indicating file attributes or an execute operation. After optionally performing additional processing, at 194, the routine determines whether to continue. If so, the routine proceeds to 174 and if not returns.

The above description of illustrated embodiments, including what is described in the Abstract, is not intended to be exhaustive or to limit the various embodiments to the precise forms disclosed. Although specific embodiments of and examples are described herein for illustrative purposes, various equivalent modifications can be made without departing from the spirit and scope of the invention, as will be recognized by those skilled in the relevant art. The teachings provided herein can be applied to other systems and devices generally described above

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, if any, are incorporated herein by reference, in their entirety. Aspects of the various embodiments can be modified, if necessary, to employ systems, circuits and concepts of the various patents, applications and publications to provide yet further embodiments.

These and other changes can be made in light of the above-detailed description. In general, in the following claims, the terms used should not be construed to limit the invention to the specific embodiments disclosed in the specification and the claims, but should be construed to include all systems and devices that operate in accordance with the claims. Accordingly, the invention is not limited by the disclosure, but instead its scope is to be determined entirely by the following claims.

Those skilled in the art will also appreciate that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners.

In addition, while certain aspects are presented below in certain claim forms, the inventors contemplate the various aspects in any available claim form. For example, while only some aspects may currently be recited as being embodied in a computer-readable medium, other aspects may likewise be so embodied.

I/We claim:

1. A computer-readable medium whose contents cause a computer system to expose printing device functionality via a logical file system by:
creating a logical file system, by
creating one or more predefined logical directories; and
creating one or more logical files in at least some of the created directories, at least some logical files associated with at least one functionality of a printing device, the logical files including at least one status file and at least one configuration file;
mounting the logical file system;
in response to a program manipulating one or more logical files using at least one standard file operation, interacting with the printer to perform the functionality associated with the one or more logical files, wherein the standard file operations include create, write, read, and delete; and
automatically updating the at least one status file.

2. The computer-readable medium of claim 1, further by:
if the functionality associated with a logical file cannot be performed on the printer, indicating an error to the program by indicating a file input/output error.

3. The computer-readable medium of claim 1 wherein the printing device is a barcode printer.

4. The computer-readable medium of claim 1 wherein the printing device encodes data onto RFID tags.

5. The computer-readable medium of claim 1 wherein the printing device is at least one of an identification card printer, a check printer, a computer disk printer, a ticket printer, a plotter, or a printing device that encodes data on to magnetic strips.

6. The computer-readable medium of claim 1 wherein the contents are a driver.

7. The computer-readable medium of claim 1 wherein the printing device has firmware that can be updated, and wherein at least one functionality associated with one of the logical files is to update the firmware.

8. The computer-readable medium of claim 1 wherein at least one functionality associated with one of the logical files is to install a font on the printing device.

9. The computer-readable medium of claim 1 wherein at least one of the virtual directories has access to the virtual directory controlled by an access control list.

10. The computer-readable medium of claim 1 wherein at least one of the logical directories is associated with at least one functionality of a printing device, and further by:
in response to a program manipulating one or more logical directories using a standard directory operation, interacting with the printer to perform the functionality associated with the at least one logical directory, wherein the standard directory operations include create, browser, delete and format.

11. The computer-readable medium of claim 10 wherein the format operation restores factory defaults for the printing device.

12. A computer-implemented method for exposing printing device functionality via a logical file system, the method comprising:
creating a logical file system, by
creating one or more predefined logical directories; and
creating one or more logical files in the created directories, at least some of the logical files associated with at least one functionality of a printing device;
mounting the logical file system; and
in response to programs manipulating one or more logical files using a standard file operation, interacting with the printing device to perform the associated functionality, wherein the standard file operations include create, write, read, and delete.

13. The method of claim 12 further comprising:
receiving a request for remote access to the logical file system from a remote computer;
permitting remote access to logical file system to the remote computer; and
in response to the remote computer manipulating one or more logical files using a standard file operation, interacting with the printing device to perform the associated functionality.

14. The method of claim 12 wherein the printing device is a barcode printer.

15. A computing device for exposing printing device functionality via a logical file system comprising:
a memory;
a logical file system, the logical file system having one or more logical directories, the logical directories having logical files, at least some of the logical files associated with at least one functionality of a printing device; and
a first module that in response to a program manipulating one or more logical files using at least one standard file operation, performing the functionality associated with the one or more files on the printing device, wherein the standard file operations include create, write, read, and delete.

16. The computing device of claim 15 wherein the printing device is a barcode printer.

17. The computing device of claim 15 wherein the printing device encodes data onto RFID tags.

18. The computing device of claim 15 wherein the computing device is the printing device.

19. The computing device of claim 15 wherein one of the logical files is a status file, and further comprising:
a second module that automatically updates the status file.
